(19) United States
(12) Patent Application Publication
(10) Pub. No.: US 2004/0258889 A1
(43) Pub. Date: Dec. 23, 2004

(54) Direct laminated vinyl substrates

(76) Inventor: Gordon Julius, Grand Rapids, MI (US)

Correspondence Address: THE FIRM OF HUESCHEN AND SAGE, 500 COLUMBIA PLAZA, 350 EAST MICHIGAN AVENUE, KALAMAZOO, MI, 49007, US

(21) Appl. No.: 10/838,562

(22) Filed: May 4, 2004

Related U.S. Application Data
(60) Provisional application No. 60/467,900, filed on May 5, 2003.

(51) Int. Cl. B32B 3/00

(52) U.S. Cl. 428/195.1; 156/277; 264/132; 156/71; 264/271.1

(57) ABSTRACT

A new process for preparation of laminated/encapsulated substrates comprising applying an image to a permeable substrate and embedding the substrate in a resin, a new surface preparation which comprises a printed substrate which is embedded in a resin, and such laminated/embedded substrate which bears an image.

### BACKGROUND OF THE INVENTION

The imaging industry may be characterized by advances in quality, diversity and scale. These advances have promoted new applications for conventional products produced by this technology. The imaging industry may be called upon to provide/apply images to ever more varied surfaces and in applications never before thought possible.

Similarly, the materials available to the imaging industry have advanced. What was once the purview of offset printing technicians is now being challenged by many seemingly unrelated fields of expertise ranging from the information technology and computer arts to the chemical arts.

The Advertising industry has advanced with the available technology. When in the past graphic artists challenged our interests and desires, we now look to digitally reproduced crisp realistic images to motivate and captivate the consuming population.

Finally, the construction industry has changed significantly with the advent of space age technology and composites. Builders and engineers have materials and techniques available today which enable the creation of structures and effects which were heretofore unthinkable.

It is with this background that we have developed a process and a product for combining the advances in surface preparation with the advances in image technology.

### SUMMARY OF THE INVENTION

It is an object of our invention to describe a new process for preparation of laminated/encapsulated substrates comprising applying an image to a permeable substrate and embedding the substrate in a resin.

It is a further object of our invention to describe a new surface preparation which comprises a printed substrate which is embedded in a resin.

It is yet a further object of our invention to describe a laminated/embedded substrate which bears an image.

It is a further object of our invention to describe a method of preparing a laminated substrate which bears an image, such method consisting of applying an image to a substrate and embedding or laminating the substrate in a resin; the method wherein the substrate is optionally permeable; the method wherein the substrate is woven, perforated, or porous; the method wherein an image is applied to the substrate through lithography, offset imaging, silk screening or through digital imaging; the method wherein the substrate is greater than or equal to 5 feet in width; the method wherein the substrate is greater than or equal to 10 feet in width; the method wherein the substrate is greater than or equal to 16 feet in width; the method wherein the substrate is embedded or laminated in an epoxy; the method wherein the substrate is embedded or laminated in a polyurethane; the method wherein the substrate is embedded or laminated in a polyurea; the method wherein the substrate is embedded or laminated in a number of layers of an epoxy, a polyurethane or a polyurea, alone or in successive layers of at least one of an epoxy, a polyurethane or a polyurea; the method wherein the substrate is applied to at least one base layer of resin; the method wherein the substrate is applied to at least two base layers of resin; the method wherein the substrate is applied to a base layer of resin, and wherein the base layer of resin is tacky; the method wherein the embedded or laminated substrate is applied to a floor surface; the method wherein the embedded or laminated substrate is applied to a construction surface; and the method wherein the embedded or laminated substrate is applied to a vehicle surface.

Yet a further object is to describe a substrate which is printed with an image and which is embedded or laminated in a resin; the embedded or laminated substrate in which the image is a digital image; the embedded or laminated substrate which is applied to a floor surface; the embedded or laminated substrate which is applied to a construction surface; the embedded or laminated substrate which is applied to a vehicle surface; the embedded or laminated substrate which is embedded in layers of resin selected from an epoxy, a polyurethane, a polyurea, and two or more layers of at least an epoxy, a polyurethane and a polyurea; and the embedded or laminated substrate in which the substrate is woven, perforated, porous, or otherwise rendered permeable to the resin.

### BRIEF DESCRIPTION OF THE DRAWINGS

FIG. 1 depicts a cross-sectional view of the application of the surface covering of the instant invention depicting the possible layers in detail.

### DETAILED DESCRIPTION OF THE INVENTION

Imaging technology currently provides many options for image reproduction. What is more, there are ever more options for image substrate. For example, an image may be reproduced in an offset format, through conventional lithography, through silk screening, or through any number of available digital imaging techniques. Modern digital imaging techniques permit sophisticated manipulation of the image and, depending on the sophistication of the hardware and software, provide for seemingly infinite scaling of images. It is this capacity of digital imaging technology which provides great opportunities for large scale imaging.

In addition, new digital imaging processes and materials have expanded the applications for digital imaging. Digital imagery may be adapted to almost any surface. Moreover, depending on the ink and the equipment, digital imagery may be applied to a seemingly infinite variety of substrates.

We have developed a process whereby an image, optionally a digital image, may be processed, applied to a suitable substrate, and subsequently embedded in a resin which is both translucent/transparent and protective. Optionally, an image may be reproduced by a digital ink jet printer and applied to a substrate. This substrate may then be laminated, encapsulated or bonded to a solid surface between layers of resins.

Any substrate may be utilized for this purpose. For the purposes of this invention, substrates may comprise any printing medium, membrane, stock or film. Such substrates may be characterized by the ability to be printed with a variety of commercially available inks or paints. Moreover, such substrates are preferably permeable, for example woven, perforated, porous or an otherwise impermeable substrate may be rendered permeable through processes which are known in the art. Such substrates are preferably permeable to a degree appropriate to allow embedding without trapping of air pockets. Such substrates may also incorporate structure enhancing materials. Representative examples of substrates are: Mesh Supreme provided by Verseidag SeeMee UA; Ultramesh Supreme and Mesh 100 provided by Ultra Flex; Cool Mesh provided by Cooley Digital Products; PVC Supreme Mesh, Solvotex C 200 Plus 1, Solvotex C300 Plus 1, TCS Polyscrim, Solvotex TCS Flag, Solvotex TCS Flag Plus, and Solvotex Artist all provided by Neschen Accutech; and Trevira provided by Thortel.

Similarly, any commercially available ink or paint may be utilized for reproducing an image. Such ink is preferably characterized by stability, ease of handling and compatibility with both the substrate and the resin, representative examples of which are: Ultra Vu Ink provided by Vutek 5300, and Mimaki JV3 Ink provided by Mimaki JV3.

Finally, any commercially available resin may be employed; such resins may be characterized by their stability, low interaction with the substrate and ink of choice and for other physical and chemical characteristics which would be known to one skilled in the art. Resins may also be selected for durability, ability to block harmful ultraviolet light transmission through to the imaged substrate and for other reasons which may become apparent on working with the materials. Such resins may be epoxies, polyurethanes, polyureas, polymers, urethanes, ureas, acrylics, water soluble resins and lacquers.

Thus, an image may be printed onto a substrate. The finished substrate may then be applied to at least one primer layer of resin, such resin may either be dried, or more preferably is tacky or not yet cured. It is an objective of the process that the substrate be completely permeated by the applied resin and a further objective that the permeability of the substrate provides for adequate outgassing. Further applications of the same or a different resin may be applied to the resin/substrate composition, completing the lamination/encapsulation of the substrate and image. Optionally, the additional applications of resin may provide embossing to the final product, such embossing resulting from physical manipulation of the resin and/or by including materials in the resin which create a texture. This technique may provide an enhanced image, provide for increased traction over the surface of the product, or provide for other advantages which will be known to those skilled in the art.

It is envisioned that images may be applied in this manner to both fixed and moveable objects. In addition, the images may be applied to a variety of surfaces including, for example, flat and contoured surfaces.

It is with these advancements that we seek to provide a new application for such technology. Examples of practical embodiments of this invention are described below.

### EXAMPLE A

### Digital Image Applied to a Smooth Flat Surface

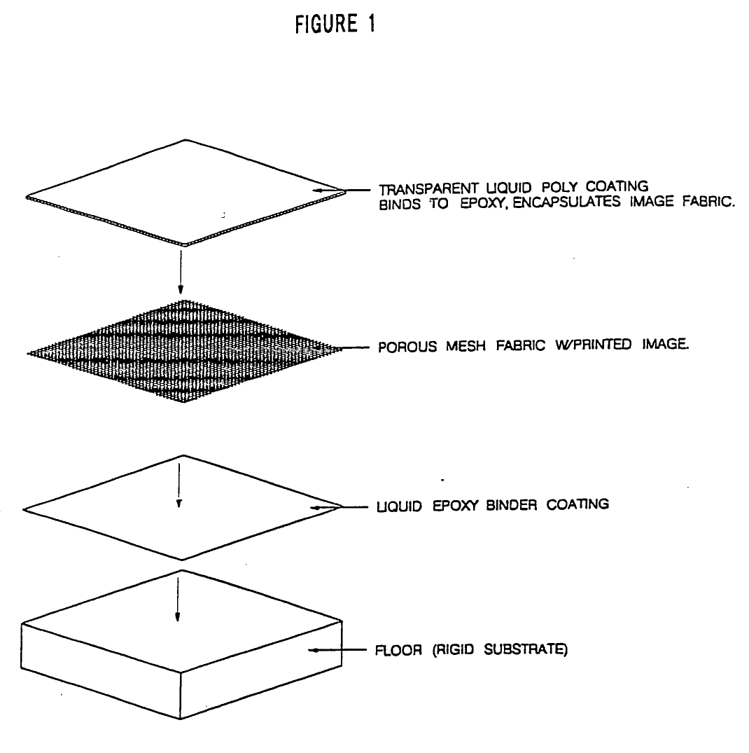

A digital image is applied to a perforated vinyl substrate (Ultramesh Supreme) in a grand format digital printer (Vutek 5300). Such image is applied using solvent based inks (Ultra Vu Ink). The printed substrate is then laid over a smooth flat surface which has been prepared by applying a base coat of an epoxy, which epoxy may either be clear or colored. The base coat may be cured. Optionally, a second base coat is tacky when the substrate is applied. Upon laying of the substrate, a second (additional) coat of the epoxy resin is applied, optionally with rollers known for such application, representative rollers may be spiked rollers or serrated rollers. The substrate/epoxy composition is massaged or worked until the resin flows completely through the substrate and all air pockets have been resolved. This combination is allowed to cure. Additional applications of epoxy may optionally be applied, preferably at least two additional layers are applied. Alternatively, additional applications of another resin may be applied to achieve some further purpose such as provision of a more durable surface, provision of a non-skid or non-glare surface, provision of an embossed surface appropriate to the image applied, or for added protection from u.v. rays. This process is depicted in FIG. 1.

### EXAMPLE B

### Digital Image or Artwork Applied to an Entire Floor or a Portion Thereof

The printed substrate (see Example A) is laid over any new or existing floor surface, such as concrete, or wood, which has been prepared by filling any imperfections or voids, and by applying a base coat of an epoxy, which epoxy may either be clear or colored. The base coat may be cured. Optionally, the base coat is tacky when the substrate is applied. Upon laying of the substrate, a second (additional) coat of the epoxy resin is applied, optionally with rollers known for such application, representative rollers may be spiked rollers or serrated rollers. The substrate/epoxy composition is massaged or worked until the resin flows completely through the substrate and all air pockets are resolved. This combination is allowed to cure. Additional applications of epoxy may optionally be applied. Alternatively, additional applications of another resin may be applied to achieve some further purpose such as provision of a more durable surface, provision of a non-skid or non-glare surface, provision of an embossed surface appropriate to the image applied, or for added protection from u.v. rays.

### EXAMPLE C

### Digital Image or Artwork Applied to Counters and Table Tops

The printed substrate (see Example A) is laid over a table or countertop surface, which has been prepared by applying a base coat of an epoxy, which epoxy may either be clear or colored. The base coat may be cured. Optionally, the base coat is tacky when the substrate is applied. Upon laying of the substrate, a second (additional) coat of the epoxy resin is applied, optionally with rollers known for such application, representative rollers may be spiked rollers or serrated rollers. The substrate/epoxy composition is massaged or worked until the resin flows completely through the substrate and all air pockets are resolved. This combination is allowed to cure. Additional applications of epoxy may optionally be applied. Alternatively, additional applications of another resin may be applied to achieve some further purpose such as provision of a more durable surface, provision of a non-skid or non-glare surface, provision of an embossed surface appropriate to the image applied, or for added protection from u.v. rays.

### EXAMPLE D

### Digital Image or Artwork Applied to a Boat Hull or Deck

The printed substrate (see Example A) is cut to shape and laid over a deck or hull surface, which has been prepared by applying a base coat of an epoxy, which epoxy may either be clear or colored. The base coat may be cured. Optionally, the base coat is tacky when the substrate is applied. Upon laying of the substrate, a second (additional) coat of the epoxy resin is applied, optionally with rollers known for such application, representative rollers may be spiked rollers or serrated rollers. The substrate/epoxy composition is massaged or worked until the resin flows completely through the substrate and all air pockets are resolved. This combination is allowed to cure. Additional applications of epoxy may optionally be applied. Alternatively, additional applications of another resin may be applied to achieve some further purpose such as provision of a more durable surface, provision of a non-skid or non-glare surface, in the case of decks, or for sanding and smoothing in the case of hulls, or for added protection from u.v. rays.

### EXAMPLE E

### Digital Image or Artwork Applied to a Swimming Pool or Spa/Hot Tub Surface

The printed substrate (see Example A) is cut to shape and tacked to the surface, which has been prepared by applying a base coat of an epoxy, which epoxy may either be clear or colored. The base coat may be cured. Optionally, the base coat is tacky when the substrate is applied. Upon laying of the substrate, a second (additional) coat of the epoxy resin is applied, optionally with rollers known for such application, representative rollers may be spiked rollers or serrated rollers. The substrate/epoxy composition is massaged or worked until the resin flows completely through the substrate and all air pockets are resolved. This combination is allowed to cure. Additional applications of epoxy may optionally be applied. Alternatively, additional applications of another resin may be applied to achieve some further purpose such as provision of a more durable surface, chemical resistance, provision of a non-skid or non-glare surface, or for added protection from u.v. rays.

### EXAMPLE F

### Digital Image or Artwork Applied to Walls

The printed substrate (see Example A) is laid over any new or existing wall surface, such as concrete masonry, plaster, gypsum board, or wood, which has been prepared by filling any imperfections or voids, and by applying a base coat of an epoxy, which epoxy may either be clear or colored. The base coat may be cured. Optionally, the base coat is tacky when the substrate is applied. Upon laying of the substrate, a second (additional) coat of the epoxy resin is applied, optionally with rollers known for such application, representative rollers may be spiked rollers or serrated rollers. The substrate/epoxy composition is massaged or worked until the resin flows completely through the substrate and all air pockets are resolved. This combination is allowed to cure. Additional applications of epoxy may optionally be applied. Alternatively, additional applications of another resin may be applied to achieve some further purpose such as provision of a more durable surface, provision of a non-skid or non-glare surface, provision of an embossed surface appropriate to the image applied, or for added protection from u.v. rays.

### EXAMPLE G

### Digital Image or Artwork Applied to Vehicles

The printed substrate (see Example A) is cut to shape and tacked to the surface, which has been prepared by applying a base coat of an epoxy, lacquer or acrylic, which may either be clear or colored. The base coat may be cured. Optionally, the base coat is tacky when the substrate is applied. Upon laying of the substrate, a second (additional) coat of the epoxy, lacquer or acrylic, is applied, optionally with rollers known for such application, representative rollers may be spiked rollers or serrated rollers. The substrate/epoxy composition is massaged or worked until the resin flows completely through the substrate and all air pockets are resolved. This combination is allowed to cure. Additional applications of epoxy, lacquer or acrylic may optionally be applied for sanding and smoothing. Alternatively, additional applications of another resin may be applied to achieve some further purpose such as provision of a more durable or non-glare surface, or for added protection from u.v. rays.

It is to be understood that the invention is not to be limited to the exact details of operation, or to the exact compositions, methods, procedures, or embodiments shown and described, as obvious modifications and equivalents will be apparent to one skilled in the art, and the invention is therefore to be limited only by the full scope which may legally be accorded to the appended claims.

What is claimed:

1. A method of preparing a laminated substrate which bears an image, such method consisting of applying an image to a substrate and embedding or laminating the substrate in a resin.

2. The method of claim 1, wherein the substrate is optionally permeable.

3. The method of claim 1, wherein the substrate is woven, perforated, or porous.

4. The method of claim 1, wherein an image is applied to the substrate through lithography, offset imaging, silk screening or through digital imaging.

5. The method of claim 1, wherein the substrate is greater than or equal to 5 feet in width.

6. The method of claim 1, wherein the substrate is greater than or equal to 10 feet in width.

7. The method of claim 1, wherein the substrate is greater than or equal to 16 feet in width.

8. The method of claim 1, wherein the substrate is embedded or laminated in an epoxy.

9. The method of claim 1, wherein the substrate is embedded or laminated in a polyurethane.

10. The method of claim 1, wherein the substrate is embedded or laminated in polyurea.

11. The method of claim 1, wherein the substrate is embedded or laminated in a number of layers of an epoxy, a polyurethane or a polyurea, alone or in successive layers of at least one of an epoxy, a polyurethane or a polyurea.

12. The method of claim 1, wherein the substrate is applied to at least one base layer of resin.

13. The method of claim 1, wherein the substrate is applied to at least two base layers of resin.

14. The method of claim 1, wherein the substrate is applied to a base layer of resin, and wherein the base layer of resin is tacky.

15. The method of claim 1, wherein the embedded or laminated substrate is applied to a floor surface.

16. The method of claim 1, wherein the embedded or laminated substrate is applied to a construction surface.

17. The method of claim 1, wherein the embedded or laminated substrate is applied to a vehicle surface.

18. A substrate which is printed with an image and which is embedded or laminated in a resin and applied to a surface.

19. The embedded or laminated substrate of claim 18, in which the image is a digital image.

20. The embedded or laminated substrate of claim 18, which is applied to a floor surface.

21. The embedded or laminated substrate of claim 18, which is applied to a construction surface.

22. The embedded or laminated substrate of claim 18, which is applied to a vehicle surface.

23. The embedded or laminated substrate of claim 18, which is embedded in layers of resin selected from an epoxy, a polyurethane, a polyurea, and two or more layers of at least an epoxy, a polyurethane and a polyurea.

24. The embedded or laminated substrate of claim 18, in which the substrate is woven, perforated, porous, or otherwise rendered permeable to the resin.
